(19) United States
(12) Patent Application Publication
(10) Pub. No.: US 2025/0101236 A1
(43) Pub. Date: Mar. 27, 2025

(54) HIGH-TEMPERATURE-RESISTANT WATER-BASED VARNISH, PREPARATION METHOD THEREFOR, AND USE THEREOF

(71) Applicant: Beijing University of Chemical Technology, Beijing (CN)

(72) Inventors: Xiaojin YANG, Beijing (CN); Shaohua SUN, Beijing (CN); Haiqiao WANG, Beijing (CN)

(21) Appl. No.: 18/728,181

(22) PCT Filed: Mar. 29, 2023
(86) PCT No.: PCT/CN2023/084677

§ 371 Date: Jul. 11, 2024

(30) Foreign Application Priority Data
Mar. 20, 2022 (CN) 202210330757.1

(51) Int. Cl. C09D 5/02; C09D 5/18; C09D 7/45; C09D 7/61; C09D 125/14; C09D 133/06

(52) U.S. Cl. CPC C09D 5/022; C09D 5/027; C09D 5/18; C09D 7/45; C09D 7/61; C09D 125/14; C09D 133/064

(57) ABSTRACT

A high-temperature-resistant water-based varnish, comprising the following components in parts by weight: 80-90 parts of an acrylic emulsion and 10-20 parts of a zinc ammonia polytetrafluoroethylene emulsion. The solid content of the acrylic emulsion is 45-55 wt %, and the solid content of the zinc ammonia polytetrafluoroethylene emulsion is 45-55 wt %. Further disclosed are a preparation method for the high-temperature-resistant water-based varnish and an obtained high-temperature-resistant coating; the temperature resistance of the obtained high-temperature-resistant coating is not less than 220° C.

### FIELD OF THE INVENTION

The present invention relates to a high-temperature-resistant and water-based varnish (or gloss oil), a method for preparing the same, and use of the same, and the present invention is in a field of material chemistry.

### PRIOR ART

A varnish is a basic material in the packaging and printing field, is capable of protecting pictures and texts, and has a beautifying effect. The varnish contains three major parts of film formers, such as a resin, a solvent and an adjuvant (except for a UV varnish). Organic solvent-based varnish, which is flammable, explosive and highly toxic, not only pollutes the environment, wastes resources, but also has high cost. Therefore, the water-based varnishes prepared by replacing an organic solvent with water have obvious advantages and have become a main kind of varnish varieties. There are many applications requiring high-temperature resistant varnish in the printing and packaging process, such as gold stamping, silver stamping and preprinting for making a corrugated paper box, long time stacking, storing or transporting printed heavy matters at relatively high temperatures. The currently available water-based varnish products are not resistant to such high temperatures and the printing quality problems occur frequently especially when large fluctuations of temperature are encountered.

D1 (CN109721914A) discloses a method which comprises steps of adding an adjuvant consisting of silicone and a polyethylene wax emulsion into an aqueous cinnamic acid resin, performing uniform stirring, then adding into solvents ethanol and deionized water, performing stirring, and adjusting a viscosity to 15±2 s measured by using a Zahn cup 4 #, and a pH of 8.0±0.5 to prepare a high-temperature-resistant and water-based varnish. The adjuvant used in all examples of D1 is obtained by mixing silicone with a polyethylene wax emulsion. Those skilled in the art know that polyethylene is poor in heating resistance but good in cooling resistance, and has a lower melt softening temperature than that of acrylic resin, while silicone has excellent thermal stability. Thus, it is judged in principle that silicone in the document D1 plays a critical role in improving the temperature resistance of the water-based varnish, while polyethylene acts to improve smoothness and friction resistance of a coating.

D2 (CN104829775A) discloses a method for preparing a zinc ion crosslinked core-shell acrylic ionomer emulsion and a method for preparing an indoor wall humidity controlling coating, and the wall coating and the claimed water-based varnish belong to different application fields. D2 teaches that a core-shell acrylic ionomer is crosslinked with the added zinc ions.

CN105694602A discloses a method for preparing a high-gloss, high-temperature-resistant and water-based varnish, wherein 8-15% SMA (a crystalline copolymer of styrene and maleic anhydride) is used; but the high temperature resistance does not exceed 190° C.

CN108330734A discloses a highly anti-adhesion, high-temperature-resistant and environment-friendly water-based preprint varnish and a method for preparing the same, wherein a water-soluble acrylate copolymer, a nano zinc oxide dispersion emulsion, a fluorosilicon modified wax emulsion and the like are used, and a mounting temperature requirement of 160-220° C. can be satisfied.

CN110128875A discloses a self-crosslinking emulsion for a water-based ink in flexographic printing, wherein self-crosslinking monomers, such as glycidyl methacrylate, acrylamide and DAAM/ADH, and metal ion complexes and the like, need to be used, and an aqueous resin is also added; however, its technical solution is relatively complicated, and in particular, the high temperature performance of the resulting product is still relatively low.

In prior art, the temperature of high-temperature resistant varnish products has not exceeded 220° C., and their water resistance of a varnish film has not yet met the market needs. The present invention is provided to solve the above problems.

### SUMMARY OF THE INVENTION

An object of the present invention is to provide a high-temperature-resistant and water-based varnish. Polymers in a high-temperature-resistant coating obtained from the high-temperature-resistant and water-based varnish are not only crosslinked by zinc ions, but also are made to act synergistically with polytetrafluoroethylene, and the obtained high-temperature-resistant coating is resistant to temperature not lower than 220° C.

Thus, according to the first aspect of the present invention, there is provided a high-temperature-resistant and water-based varnish, including the following components by weight: 80-90 parts of an acrylic emulsion and 10-20 parts of a zinc ammonia polytetrafluoroethylene emulsion, in which a solid content of the acrylic emulsion is 45-55 wt %, and a solid content of the zinc ammonia polytetrafluoroethylene emulsion is 45-55 wt %.

Preferably, polymer monomers used in the acrylic emulsion include the following components by weight: 1-3 parts of acrylic acid, 10-20 parts of butyl acrylate, 10-15 parts of methyl methacrylate, and 10-15 parts of styrene; and the polymers in the acrylic emulsion have a number-average molecular weight of greater than 200,000.

Preferably, the zinc ammonia polytetrafluoroethylene emulsion is prepared from raw materials including the following components by weight: 0.3-0.8 parts of zinc chloride, 3-15 parts of polytetrafluoroethylene wax powder, and 1-2 parts of an emulsifier.

Preferably, the emulsifier is OP-10.

According to a second aspect of the present invention, there is provided a method for preparing a high-temperature-resistant and water-based varnish, including the steps of:
(1) performing polymerization to obtain an acrylic emulsion;
(2) preparing a zinc ammonia polytetrafluoroethylene emulsion; and
(3) adding the zinc ammonia polytetrafluoroethylene emulsion obtained in the step (2) into the acrylic emulsion obtained in the step (1) to be mixed, allowing the obtained mixture to settle, and performing a filtration to obtain the high-temperature-resistant water-based varnish.

Preferably, the polymerization of the acrylic emulsion in the step (1) includes the steps of:
(A) uniformly mixing certain amounts of water, ammonia water, an emulsifier, and ammonium persulfate to obtain a mixed solution; and uniformly mixing monomers in a certain ratio to obtain a monomer mixture, in which the monomers include acrylic acid, butyl acrylate, methyl methacrylate, and styrene; and a mass ratio of the water, the ammonia water, the emulsifier, ammonium persulfate, acrylic acid, butyl acrylate, methyl methacrylate and styrene=(45-55):(2-5):(1-2):(0.5-1):(1-3):(10-20):(10-15):(10-15); and
(B) adding dropwise the monomer mixture into the mixed solution at 80±2° C., carrying out a reaction for 2-3 hours, and allowing the resulting reaction solution to settle for 25-30 minutes, so that the acrylic emulsion is obtained after completion of the reaction.

Preferably, the preparing the zinc ammonia polytetrafluoroethylene emulsion in the step (2) includes the steps of:
(a) dissolving an emulsifier and zinc chloride into deionized water, adding polytetrafluoroethylene wax powder thereinto, and performing a dispersion with a colloid mill for not less than three times, wherein the polytetrafluoroethylene wax powder used has a number-average molecular weight of 0.5 million to 2 million; and a mass ratio of the deionized water, the emulsifier, the zinc chloride and the polytetrafluoroethylene wax powder is (5-20):(1-2):(0.3-0.8):(3-15); and
(b) adding ammonia water stepwise at 3000-5000 rpm thereinto, and controlling a temperature to be 30-50° C. and a pH value to be 9.3-11.8; and carrying out a reaction to obtain the zinc ammonia polytetrafluoroethylene emulsion.

Preferably, a rotation speed of the colloid mill is 9000-13000 rpm, and the colloid mill has a gap of 0.15-3 mm.

Preferably, the ammonia water has a concentration of 18-22 wt %; and the emulsifier is OP-10.

According to a third aspect of the present invention, there is provided usage of the high-temperature-resistant and water-based varnish, i.e., a high-temperature-resistant coating, in which a break-down temperature of an obtained high-temperature-resistant coating is not less than 220° C.

In particular, the present invention has the technical concept and beneficial effects discussed hereafter.

1. The polymers in the acrylic emulsion of the present invention own a large molecular weight, have a number-average molecular weight of greater than 200,000, and have a greater molecular weight than that of solution type resin in the prior art.

2. An appropriate amount of carboxyl is added into an emulsion polymer of the present invention, and can react with a zinc-ammonia complex ion. In a process of forming a coating, as a drying process proceeds, moisture and ammonia are dissipated, a stable high molecular zinc carboxylate is formed within the coating, and a high molecular chain is crosslinked by zinc ions; and thus, a high temperature resistance and water resistance of the obtained coating are remarkably improved.

3. The high-temperature-resistant coating obtained in the present invention is resistant to a temperature higher than 220° C., up to 232° C., and the water resistance of the high-temperature-resistant coating is obviously better. Oppositely, it is difficult for the temperature resistance of a water-based varnish coating in the prior art to reach 220° C. Thus, the high temperature resistance and water resistance of a high-temperature-resistant coating obtained from the varnish of the present invention are superior to those of a coating obtained from a varnish obtained in the prior art; and a drying speed, the wear resistance and the adhesion of the coating of the present invention can also meet requirements in the packaging and printing field.

4. The claimed method for preparing the coating is simplified, does not need addition of a self-crosslinking monomer and aqueous resin, but merely needs addition of the zinc ammonia polytetrafluoroethylene emulsion.

### BRIEF DESCRIPTION OF THE DRAWINGS

FIG. 1A and FIG. 1B are photographs of a coating of a water-based varnish obtained in Example 1 in the present invention before drying and after drying, respectively.

FIG. 2 is an infrared spectrogram of the coating of the water-based varnish obtained in Example 1 in the present invention.

### BEST MODES FOR CARRYING OUT THE INVENTION

In order to make the objects, technical solutions and advantages of the present invention clear, the present invention will be further described below in detail with reference to its examples. It should be understood that the specific examples described herein are merely illustrative of the present invention and are not intended to limit the present invention. Where specific techniques or conditions are not specified in the examples, they can be carried out according to the techniques or conditions described in the prior art literature or according to the present specification. The reagents or instruments whose manufacturers are not specified are conventional products which can be obtained by purchase.

### Method for Testing High Temperature Resistance:

A film is coated with a varnish, and heat sealings are performed with a heat seal tester at different temperatures and different pressures after drying, and after a certain period of time, it is observed whether a coating is detached and whether a surface is intact and cracked. Typical test conditions include a temperature of 160-220° C., a pressure of 0.2 MPa, and a time of 1-2 seconds.

### Method for Testing Water Resistance:

Water is dripped onto a dried coating, and after a water drop is naturally dried, a change of a profile of the water drop is observed.

### Example 1: Preparing a High-Temperature-Resistant and Water-Based Varnish/a High-Temperature-Resistant Coating

Step 1, Polymerization of an acrylic emulsion, including the following steps:
(1) 50 g of water, 2 g of 20 wt % ammonia water, 1 g of an emulsifier OP-10, and 0.5 g of ammonium persulfate are uniformly mixed to obtain a mixed solution; and 1 g of acrylic acid, 10 g of butyl acrylate, 10 g of methyl methacrylate and 10 g of styrene are uniformly mixed to obtain a monomer mixture; and
(2) the monomer mixture is slowly added dropwise into the mixed solution at 80° C., within 1.5 hours by controlling a dropwise adding rate, a reaction therebetween is continued to be carried out under stirring for 1 hour after the addition of monomers is completed, then a cooling is performed so as to obtain the acrylic emulsion.

Step 2, Preparation of a zinc ammonia polytetrafluoroethylene emulsion, including the following steps:
(1) 1 g of an emulsifier OP-10 and 0.35 g of zinc chloride are dissolved into 8 g of deionized water, 6.5 g of polytetrafluoroethylene wax powder is added to be mixed uniformly, and a dispersion is performed with a colloid mill for three times, in which a rotation speed of the colloid mill is 10000 rpm and the colloid mill has a gap of 0.15 mm. The polytetrafluoroethylene wax powder has a number-average molecular weight of 500,000; and
(2) ammonia water with a concentration of 18 wt % is added stepwise under stirring at a high speed of 5000 rpm, a temperature is controlled to be 40° C., and a pH is controlled to be 10.0; and a reaction is carried out to obtain the zinc ammonia polytetrafluoroethylene emulsion.

Step 3, Production of a high-temperature-resistant and water-based varnish

2 g of the zinc ammonia polytetrafluoroethylene emulsion obtained in the step 2 is slowly added into 8 g of the acrylic emulsion obtained in the step 1, a mixing is continued to be performed at a high speed for 0.5 hours after completion of the addition, and filtering, metering, and packaging are performed to obtain the high-temperature-resistant and water-based varnish.

Step 4, Production of a Coating

Applying for the obtained high-temperature-resistant and water-based varnish is performed to obtain a coating; and the coating is subjected to a high temperature resistance test and a water resistance test.

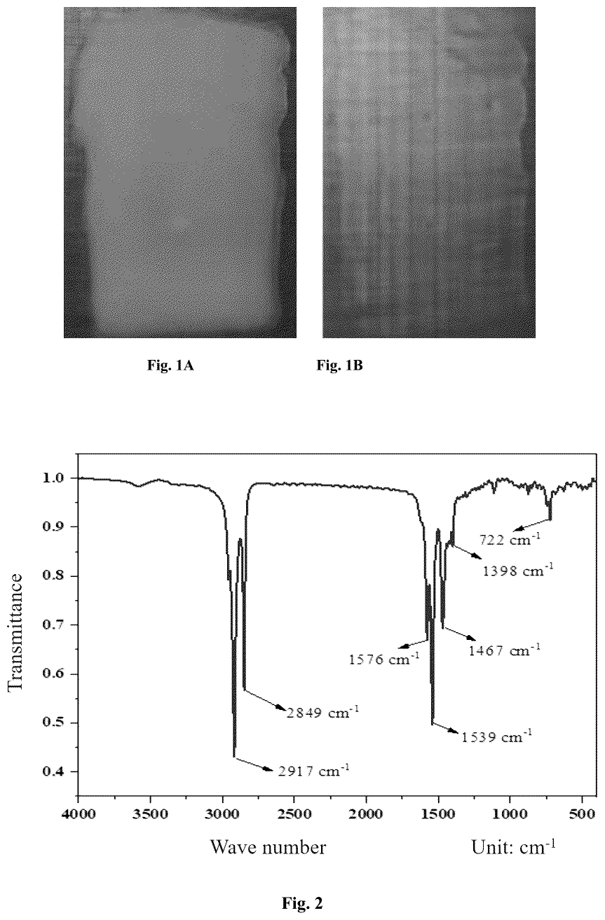

FIG. 1A and FIG. 1B are photographs of the wet and dry coatings of the obtained high-temperature-resistant and water-based varnish, respectively.

FIG. 2 is an infrared spectrogram of the dry coating with the obtained high-temperature-resistant and water-based varnish.

As shown in FIG. 1A and FIG. 1B, the dry coating is transparent.

As shown in FIG. 2, zinc carboxylate is formed in the coating; and 1539 cm⁻¹ is of antisymmetric stretching of —COO—Zn, 1576 cm⁻¹ is of antisymmetric stretching of —COO⁻, and 1398 cm⁻¹ is of symmetric stretching of —COO⁻, so a stable high molecular zinc carboxylate is formed in the coating, and a high molecular chain is crosslinked by zinc ions, in which 2917 cm⁻¹ is of an asymmetrical stretching vibration of —CH₂—, 2849 cm⁻¹ is of a symmetric stretching vibration of —CH₂—, and 1467 cm⁻¹ is of a scissor vibration of —CH₂—.

The high temperature resistance and the water resistance of the obtained coating are tested, and the test results are as follows:

High temperature resistance test result: the obtained coating can withstand 232° C.

Water resistance test result: the coating of the present invention has no obvious fuzzy change. Oppositely, both the coatings of the conventional varnish and coatings in the Comparative examples demonstrate fuzzy changes. This indicates that the water resistance of a cross-linked coating in the present invention is improved.

As shown in the above test results: the high temperature resistance and the water resistance of the coating of the present invention are superior to those of a coating of a varnish obtained in the prior art.

### Example 2: Preparing a High-Temperature-Resistant and Water-Based Varnish/a High-Temperature-Resistant Coating

Step 1, Polymerization of an acrylic emulsion, including the following steps:
(1) 55 g of water, 4 g of 20 wt % ammonia water, 2 g of an emulsifier OP-10, and 1.0 g of ammonium persulfate are uniformly mixed to obtain a mixed solution; and 2 g of acrylic acid, 20 g of butyl acrylate, 15 g of methyl methacrylate and 15 g of styrene are uniformly mixed to obtain a monomer mixture; and
(2) the monomer mixture is slowly added dropwise into the mixed solution at 80° C., within 1.5 hours by controlling a dropwise adding rate, a reaction therebetween is continued to be carried out under stirring for 1 hour after addition of monomers is completed, then a cooling is performed so as to obtain the acrylic emulsion.

Step 2, Preparation of a zinc ammonia polytetrafluoroethylene emulsion, including the following steps:
(1) 2 g of an emulsifier OP-10 and 0.6 g of zinc chloride are dissolved into 10 g of deionized water, 9 g of polytetrafluoroethylene wax powder is added to be mixed uniformly, and their dispersion is performed with a colloid mill for three times, in which a rotation speed of the colloid mill is 10000 rpm and the colloid mill has a gap of 0.15 mm. The polytetrafluoroethylene wax powder has a number-average molecular weight of 1 million;
(2) ammonia water is added stepwise under stirring at a high speed of 5000 rpm, a temperature is controlled to be 45° C., and a pH value is controlled to be 10.0; and a reaction therebetween is carried out to obtain the zinc ammonia polytetrafluoroethylene emulsion.

Step 3, Production of the high-temperature-resistant and water-based varnish.

1.5 g of the zinc ammonia polytetrafluoroethylene emulsion obtained in the step 2 is slowly added into 8 g of the acrylic emulsion obtained in the step 1, their mixing is continued to be performed at a high speed for 0.5 hours after completion of the addition, and filtering, metering, and packaging are performed one by one, so as to obtain the high-temperature-resistant and water-based varnish.

Step 4, Production of a coating

a corrugated box is coated with the obtained high-temperature-resistant and water-based varnish to obtain a coating; and the coating is subjected to a high temperature resistance test and a water resistance test.

High temperature resistance test result: the obtained coating can withstand 229° C.

Water resistance test result: the same as that in Example 1.

### Comparative Example 1

Comparative example 1 is the same as Example 1, except that ammonia water is not added during the preparation of the zinc ammonia polytetrafluoroethylene emulsion in the step 2. The high-temperature-resistant and water-based varnish is obtained with a high amount of solids precipitated. Applying for the obtained water-based varnish is performed so as to obtain a coating; the coating is subjected to a high temperature resistance test and a water resistance test, and as a result, the obtained coating can withstand a temperature of not more than 200° C. The coating has a fuzzy change and the water resistance of the coating is inferior to that of the coating obtained in Example 1. It is indicated that a pH value is controlled in an alkaline range so that zinc ions sufficiently crosslink the polymers.

### Comparative Example 2

Comparative example 2 is the same as Example 1, except that only zinc chloride and ammonia water are added, and polytetrafluoroethylene wax powder is not added in the step 2. Applying for the obtained water-based varnish is performed so as to obtain a coating; the coating is subjected to a high temperature resistance test and a water resistance test, and as a result, the obtained coating can withstand a temperature of 205° C., and the water resistance of the coating is also better, but not as good as that in Example 1. This indicates that zinc ammonia complex plays a significant role, but since no polytetrafluoroethylene is used to play a synergistic role, the temperature resistance and water resistance of the coating need to be improved.

### Comparative Example 3

Comparative example 3 is the same as Example 1, except that zinc chloride and ammonia water are not added, and only polytetrafluoroethylene wax powder is added in the step 2. Applying for the obtained water-based varnish is performed to obtain a coating; the coating is subjected to a high temperature resistance test and a water resistance test, and as a result, the obtained coating can withstand a temperature of less than 120° C., which is slightly higher than that of a pure acrylic emulsion film. It is indicated that a polymer is not crosslinked by zinc ions, and that polytetrafluoroethylene and an acrylic polymer have no synergistic effect; and thus, the temperature resistance of the obtained coating is poor.

According to D1, the polyethylene wax emulsion is replaced with the polytetrafluoroethylene wax emulsion, products obtained by the conventional technical means, i.e., using polytetrafluoroethylene wax powders of different molecular weights and the like, are resistant to temperature not exceeding 120° C. (see Comparative example 3).

“Preparation of a zinc ion crosslinked core-shell acrylic ionomer emulsion” described in D2 includes the steps of “adding 1-5 parts of zinc oxide, 2-10 parts of ammonium carbonate, 1-5 parts of ammonia water and 10-20 parts of distilled water into a small beaker, and carrying out a reaction under stirring to obtain a clear and transparent zinc ammonia complex solution; then adding dropwise the zinc ammonia complex solution into the above core-shell acrylic ionomer emulsion, and carrying out a reaction under stirring at 60-90° C. for 0.5-2 hours to prepare a white zinc ion crosslinked core-shell acrylic ionomer emulsion”. In D2, the water-based acrylic resin and a carboxylic acid monomer are crosslinked by using a zinc ammonia complex solution as a crosslinking agent, and the obtained water-based varnish is resistant to temperature only up to 205° C. (see Comparative example 2).

The solution of “preparation of the zinc ion crosslinked core-shell acrylic ionomer emulsion” described in D2 is essentially different from the solution of “preparation of the zinc ammonia polytetrafluoroethylene emulsion” of the present invention. It cannot be derived from D2 for the claimed step (a) of “dissolving an emulsifier and zinc chloride into deionized water, adding polytetrafluoroethylene wax powder, and performing dispersion with a colloid mill and dispersion conditions thereof” in the present invention; and the claimed step (b) of “adding ammonia water stepwise, and controlling a temperature to be 30-50° C. and a pH to be 9.3-11.8” is also significantly different from D2 with its temperature (60-90° C.) conditions. The technical solution for preparing the zinc ammonia polytetrafluoroethylene emulsion of the present invention seems to be simple after publication and is not readily conceivable beforehand.

D2 discusses the “high temperature resistance” and “water resistance” of the indoor wall coating, which is a different spirit and concept from the “high temperature resistance” and “water resistance” in the printing field, and a temperature resistance test method of the coating of the present invention is different from a temperature resistance test method of the coating of D1 or D2, and the temperatures of the coatings obtained by the three temperature resistance test methods are also not comparable. The temperature resistance test method for the water-based varnish in the present invention is similar to a temperature resistance test method for printing inks and more accurately reflects the temperature resistance of a printing process.

The polytetrafluoroethylene emulsion of the present invention plays a role in promoting a function of the zinc ammonia complex solution. As shown in the experimental results of Comparative example 2 in the present invention, the zinc ammonia complex solution alone can indeed improve the temperature resistance of the coating (see Comparative example 2 of the present invention); but in the presence of polytetrafluoroethylene, its temperature resistance of the coating is improved more significantly, from 205° C. to 229° C. (comparing Comparative example 2 with Example 1), indicating that the polytetrafluoroethylene emulsion plays a synergistic role in cooperating with the zinc ammonia complex solution, and in the presence of polytetrafluoroethylene and zinc chloride, even without the addition of ammonia water, the temperature resistance of the resulting coating is still high, and although the temperature resistance does not exceed 200° C. (see Comparative example 1 of the present invention), it is obviously improved compared with the temperature resistance of the acrylic emulsion alone (less than 120° C., see Comparative example 3), which is due to the dispersion and milling of polytetrafluoroethylene wax powder and zinc chloride by using the colloid mill and the stepwise addition of ammonia water and the control of conditions thereof in subsequent emulsion preparation in the claimed method of the present invention. It is not absolutely necessary to take polytetrafluoroethylene wax with a larger molecular weight to make the coating with better high temperature resistance, corrosion resistance and the like, because, as shown in Comparative example 3 of the present invention, the temperature resistance (less than 120° C.) of the coating with only polytetrafluoroethylene wax added is only slightly higher than that of the pure acrylic emulsion film.

Although D1 teaches that polyethylene wax can be added into a varnish, an adjuvant used in all examples of D1 is obtained by mixing silicone with a polyethylene wax emulsion, i.e., in fact, silicone is an essential component of a varnish in D1. Those skilled in the art know that silicone has very good temperature resistance properties, while polyethylene wax is bad in temperature resistance, those skilled in the art could derive from the teaching of D1 that the temperature resistance of a varnish film is improved only because of the addition of silicone, that is, there is no technical enlightenment that the addition of the polyethylene wax improves the temperature resistance of the varnish, while the polytetrafluoroethylene wax powder is inventively used in the present invention. As described above, polytetrafluoroethylene plays a synergistic role in promoting function of the zinc ammonia complex solution, and the addition of polytetrafluoroethylene improves the temperature resistance of the coating more obviously. Therefore, there is no technical enlightenment from the polyethylene wax of D1 that polytetrafluoroethylene plays a synergistic role in making the zinc ammonia (complex) solution fully effective in the present invention.

Different from the prior art, the claimed method does not use silicone, but uses the zinc ammonia polytetrafluoroethylene emulsion, and adopts a zinc ammonia crosslinking technology to improve the temperature resistance of the coating, in which the polytetrafluoroethylene plays a synergistic role in impacting the zinc ammonia complex solution well, the “two-steps” for preparing the zinc ammonia polytetrafluoroethylene emulsion play a key role in making a synergistic reaction in the present invention, and the unexpected technical effect that the temperature resistance reaches 232° C. is obtained (see Example 1).

Comparative example 1 of the present invention shows that even if polytetrafluoroethylene wax powder is added but ammonia water is not added, the obtained high-temperature-resistant and water-based varnish is resistant to a temperature not exceeding 200° C., and the uniformity and stability are poor (more solid matters are precipitated, the coating shows a fuzzy change, and the water resistance is inferior to that in Example 1).

Comparative example 3 of the present invention shows that when polytetrafluoroethylene wax powder is added but zinc chloride and ammonia water are not added, the obtained product is resistant to a temperature not exceeding 120° C.

In the present invention, the acrylic emulsion is added into the zinc ammonia polytetrafluoroethylene emulsion for crosslinking. If a water-based acrylic resin and a carboxylic acid monomer are crosslinked by using a zinc ammonia complex solution as a crosslinking agent, the highest temperature resistance of the obtained water-based varnish is 205° C. (see Comparative example 2). Obviously, the inventive steps are required to obtain a water-based varnish product which is resistant to a temperature exceeding 220° C. according to the present invention. In the field of aqueous ink printing, at present, water-based varnish products are resistant to a high temperature not exceeding 220° C., and the water resistance of a varnish film has not yet met market requirements. The temperature resistance test method for the water-based varnish in the present invention is similar to a temperature resistance test method for printing inks and more accurately reflects the temperature resistance of a printing process.

According to the present invention, the zinc ammonia polytetrafluoroethylene emulsion is prepared by using a “two-step” technique, and the obtained product is resistant to temperature up to 232° C., which cannot be predicted (see Example 1 and Comparative examples 1-3).

The polytetrafluoroethylene emulsion of the present invention plays a promoting role in making the zinc ammonia complex solution fully effective. As shown in the experimental results of Comparative example 2 in the present invention, the zinc ammonia complex solution alone can indeed improve the temperature resistance of the coating (see Comparative example 2); but in the presence of polytetrafluoroethylene, the temperature resistance of the coating is improved more significantly, from 205° C. to 229° C. (comparing Comparative example 2 with Example 1), indicating that the polytetrafluoroethylene emulsion plays a synergistic role in improving an effectiveness of the zinc ammonia complex solution. And in the presence of polytetrafluoroethylene and zinc chloride, even without the addition of ammonia water, the temperature resistance of the resulting coating is still high (see Comparative example 1), which is significantly improved compared with the temperature resistance of the acrylic emulsion alone (see Comparative example 3). This may be the effect of milling polytetrafluoroethylene wax powder and zinc chloride by using the colloid mill in the step (a) of the claimed method. This is clearly an unexpected technical effect over the prior art.

Polytetrafluoroethylene wax powder is used in the present invention, and the synergistic impact for crosslinking polytetrafluoroethylene with zinc ammonia is a major contribution in improving the temperature resistance of the water-based varnish of the present invention and obtaining unexpected technical merits.

In the present invention, the high-temperature-resistant and water-based varnish is prepared from the acrylic emulsion and the polytetrafluoroethylene emulsion as raw materials by taking advantages of a zinc crosslinking technique. The two-steps in preparing the claimed zinc ammonia polytetrafluoroethylene emulsion allows the present invention to obtain the unexpected technical merits (see Examples 1-2 and Comparative examples 1-3).

The above are only preferred examples of the present invention, and are not intended to limit the present invention, and any modification, equivalent replacement, improvement and the like made within the spirit and concept of the present invention should be included in the scope of protection defined by the appended claims of the present invention.

1. A method for preparing a high-temperature-resistant and water-based varnish, wherein the high-temperature-resistant and water-based varnish comprises the following components by weight:
80-90 parts of an acrylic emulsion and 10-20 parts of a zinc ammonia polytetrafluoroethylene emulsion, in which a solid content of the acrylic emulsion is 45-55 wt %, and a solid content of the zinc ammonia polytetrafluoroethylene emulsion is 45-55 wt %;
the acrylic emulsion comprises polymer monomers and an emulsifier, in which the monomers comprise the following components by weight: 1-3 parts of acrylic acid, 10-20 parts of butyl acrylate, 10-15 parts of methyl methacrylate, and 10-15 parts of styrene, and the emulsifier is of 1-2 parts by weight; the polymers in the acrylic emulsion have a number-average molecular weight of greater than 200,000;
the zinc ammonia polytetrafluoroethylene emulsion is prepared from raw materials comprising the following components by weight: 0.3-0.8 parts of zinc chloride, 3-15 parts of polytetrafluoroethylene wax powder, and 1-2 parts of an emulsifier; a polytetrafluoroethylene wax powder used herein has a number-average molecular weight of 0.5 million to 2 million;
the method for preparing the high-temperature-resistant and water-based varnish comprises the steps of:
(1) preparing the acrylic emulsion by performing a polymerization;
(2) preparing the zinc ammonia polytetrafluoroethylene emulsion, with the steps of:
(a) dissolving the emulsifier and zinc chloride into deionized water, adding the polytetrafluoroethylene wax powder hereinto, and performing their dispersion with a colloid mill for not less than three times, in which the polytetrafluoroethylene wax powder used herein has a number-average molecular weight of 0.5 million to 2 million; a mass ratio of the deionized water, the emulsifier, the zinc chloride, and the polytetrafluoroethylene wax powder is (5-20):(1-2):(0.3-0.8):(3-15); a rotation speed of the colloid mill is 9000-13000 rpm, and the colloid mill has a gap of 0.15-3 mm; and
(b) adding ammonia water stepwise hereinto at 3000-5000 rpm, controlling a temperature to be 30-50° C. and a pH to be 9.3-11.8, so obtaining the zinc ammonia polytetrafluoroethylene emulsion after their reaction; and
(3) adding the zinc ammonia polytetrafluoroethylene emulsion obtained in the step (2) into the acrylic emulsion obtained in the step (1) to be mixed with each other, allowing an obtained mixture stewing, and performing the filtration of the obtained mixture, to form the high-temperature-resistant and water-based varnish.

2. The method of claim 1, wherein preparing the acrylic emulsion by performing a polymerization in the step (1) comprises the steps of:
(A) uniformly and proportionally mixing water, ammonia water, the emulsifier, and ammonium persulfate to obtain a mixed solution; and uniformly and proportionally mixing monomers to obtain a monomer mixture, in which the monomers comprise acrylic acid, butyl acrylate, methyl methacrylate, and styrene in a mass ratio of water:ammonia water:emulsifier:ammonium persulfate:acrylic acid:butyl acrylate:methyl methacrylate:styrene of (45-55):(2-5):(1-2):(0.5-1):(1-3):(10-20):(10-15):(10-15); and
(B) adding dropwise the monomer mixture into the mixed solution at 80±2° C., carrying out their reaction for 2-3 hours, and allowing a resulting reaction solution on standing for 25-30 minutes, so that the acrylic emulsion is obtained after the reaction.

3. The method of claim 1, wherein the ammonia water has a concentration of 18-22 wt %; and the emulsifier is OP-10.

4. A high-temperature-resistant coating, obtained from a high-temperature-resistant and water-based varnish prepared by the method of claim 1.

5. A high-temperature-resistant and water-based varnish, comprising 80-90 wt % of an acrylic emulsion and 10-20 wt % of a zinc ammonia polytetrafluoroethylene emulsion, in which a solid content of the acrylic emulsion is 45-55 wt %, and a solid content of the zinc ammonia polytetrafluoroethylene emulsion is 45-55 wt %;
the acrylic emulsion comprise the following polymer monomers by weight: 1-3 parts of acrylic acid, 10-20 parts of butyl acrylate, 10-15 parts of methyl methacrylate, and 10-15 parts of styrene, and the acrylic emulsion also comprises 1-2 parts of an emulsifier; polymers in the acrylic emulsion have a number-average molecular weight of greater than 200,000;
the zinc ammonia polytetrafluoroethylene emulsion is prepared from raw materials comprising the following components by weight: 0.3-0.8 parts of zinc chloride, 3-15 parts of polytetrafluoroethylene wax powder, and 1-2 parts of an emulsifier; and the polytetrafluoroethylene wax powder used herein has a number-average molecular weight of 0.5 million to 2 million.

6. The high-temperature-resistant and water-based varnish of claim 5, wherein the emulsifier is OP-10.

7. A high-temperature-resistant and water-based varnish or gloss oil, prepared by a method comprising the following steps of:
(1) preparing an acrylic emulsion by performing a polymerization with the steps of:
(A) uniformly and proportionally mixing water, ammonia water, an emulsifier, and ammonium persulfate to obtain a mixed solution; and uniformly and proportionally mixing monomers to obtain a monomer mixture, the monomers comprise acrylic acid, butyl acrylate, methyl methacrylate, and styrene; and a mass ratio of the water, the ammonia water, the emulsifier, ammonium persulfate, acrylic acid, butyl acrylate, methyl methacrylate and styrene=(45-55):(2-5):(1-2):(0.5-1):(1-3):(10-20):(10-15):(10-15); and
(B) adding dropwise the monomer mixture into the mixed solution at 80±2° C., allowing their reaction for 2-3 hours, and allowing a resulting reaction solution on standing for 25-30 minutes, so that the acrylic emulsion is obtained after completing their reaction;
(2) preparing a zinc ammonia polytetrafluoroethylene emulsion, with the steps of:
(a) dissolving an emulsifier and zinc chloride into deionized water, adding a polytetrafluoroethylene wax powder thereinto, and performing their dispersion with a colloid mill for not less than three times, in which the polytetrafluoroethylene wax powder used herein has a number-average molecular weight of 0.5 million to 2 million; and a mass ratio of the deionized water, the emulsifier, zinc chloride and the polytetrafluoroethylene wax powder is (5-20):(1-2):(0.3-0.8):(3-15); and
(b) adding ammonia water stepwise hereinto at 3000-5000 rpm, controlling a temperature to be 30-50° C. and a pH to be 9.3-11.8; and forming the zinc ammonia polytetrafluoroethylene emulsion after their reaction; and
(3) adding the zinc ammonia polytetrafluoroethylene emulsion obtained in the step (2) into the acrylic emulsion obtained in the step (1) to be mixed, allowing the obtained mixture on standing or to settle, and performing a filtration of the obtained mixture, so as to produce the high-temperature-resistant water-based varnish.

8. The high-temperature-resistant and water-based varnish of claim 7, wherein a rotation speed of the colloid mill is 9000-13000 rpm, and the colloid mill has a gap of 0.15-3 mm.

9. The high-temperature-resistant and water-based varnish of claim 7, wherein the ammonia water has a concentration of 18-22 wt %; and the emulsifier is OP-10.

10. A high-temperature-resistant coating, obtained from the high-temperature-resistant and water-based varnish prepared by the method of claim 7.
